(19) United States
(12) Patent Application Publication
(10) Pub. No.: US 2010/0295835 A1
(43) Pub. Date: Nov. 25, 2010

(54) Voltage Boosting Circuit and Display Device Including the Same

(76) Inventors: Jee-Hwal Kim, Seoul (KR); Ji-Hyun Lee, Seoul (KR)

Correspondence Address: F. CHAU & ASSOCIATES, LLC, 130 WOODBURY ROAD, WOODBURY, NY, 11797, US

(21) Appl. No.: 12/708,195

(22) Filed: Feb. 18, 2010

(30) Foreign Application Priority Data
May 20, 2009 (KR) 10-2009-0044096

(51) Int. Cl. G09G 5/00; G05F 5/00

(52) U.S. Cl. 345/211; 323/299

(57) ABSTRACT

Provided are a voltage boosting circuit and a display device including the same. The voltage boosting circuit includes a booster input voltage generator configured to receive a power supply voltage, operate with a first current drive capability, and generate a booster input voltage in a switched mode in which the voltage boosting circuit switches from a standby mode to an operation mode, and configured to receive the power supply voltage, operate with a second current drive capability higher than the first current drive capability, and generate the booster input voltage in the operation mode, and a booster configured to receive the booster input voltage and generate a boost voltage.

### CROSS-REFERENCE TO RELATED APPLICATION

This application claims priority under 35 U.S.C. §119 to Korean Patent Application No. 10-2009-0044096, filed on May 20, 2009, the contents of which are herein incorporated by reference in its entirety.

### BACKGROUND

1. Technical Field

Exemplary embodiments of the present invention relate to a voltage boosting circuit, and more particularly, to a voltage boosting circuit and a display device including the same.

2. Discussion of the Related Art

A voltage boosting circuit, which is configured to generate a boost voltage higher than an input voltage, may be variously applied to various electronic devices. For example, in the case of a display device, a display driver configured to drive a display panel may require boost voltages having various levels. Thus, the display device may include a voltage boosting circuit to generate the required boost voltages having various levels.

However, to minimize power consumption, the display driver may switch from an operation mode to a standby mode during periods of disuse. In the standby mode, the voltage boosting circuit may be disabled. Thereafter, when switching from the standby mode to the operation mode, the voltage boosting circuit may be enabled and may then generate a boost voltage. In this case, an inrush current, otherwise known as an input surge current, may be inadvertently generated, thus damaging an integrated circuit (IC) of the display device.

### SUMMARY

Exemplary embodiments of the present invention provide a voltage boosting circuit capable of reducing an inrush current.

Exemplary embodiments of the present invention provide a display device including the voltage boosting circuit.

According to exemplary embodiments of the present invention, a voltage boosting circuit includes a booster input voltage generator configured to receive a power supply voltage, operate with a first current drive capability, and generate a booster input voltage in a switched mode in which the voltage boosting circuit switches from a standby mode to an operation mode, and configured to receive the power supply voltage, operate with a second current drive capability higher than the first current drive capability, and generate the booster input voltage in the operation mode. The voltage boosting circuit also includes a booster configured to receive the booster input voltage and generate a boost voltage.

The booster input voltage generator may include an input voltage controller configured to disable both a first control signal and a second control signal in the standby mode, enable the first control signal and disable the second control signal in the switched mode, enable both the first and second control signals in the operation mode, and output the first and second control signals. The booster input voltage generator may also include an input voltage driver configured to receive the power supply voltage, drive the power supply voltage with the first current drive capability in response to the first control signal in the switched mode, drive the power supply voltage with the second current drive capability in response to the first and second control signals in the operation mode, and generate the booster input voltage.

According to an exemplary embodiment of the present invention, the input voltage driver may include a first transistor connected between a terminal to which the power supply voltage is applied and a terminal from which the booster input voltage is output, the first transistor having a gate to which the first control signal is applied. A second transistor is connected between the terminal to which the power supply voltage is applied and the terminal from which the booster input voltage is output, the second transistor having a gate to which the second control signal is applied.

According to an exemplary embodiment of the present invention, the input voltage driver, may include a reference voltage generator configured to receive the power supply voltage and generate a reference voltage. A comparison voltage generator may be configured to receive the reference voltage and a feedback voltage, compare the feedback voltage with the reference voltage, and output a comparison voltage in response to a difference between the reference voltage and the feedback voltage. An output unit may be configured to receive the power supply voltage in response to the comparison voltage and generate the booster input voltage, have the first current drive capability in response to the first control signal in the switched mode, and have the second current drive capability in response to the first and second control signals in the operation mode. A feedback voltage generator may be configured to receive the booster input voltage and generate the feedback voltage in proportion to the booster input voltage. The output unit may include a first transistor connected to a terminal to which the power supply voltage is applied, the first transistor having a gate to which the first control signal is applied. The output unit may also include a second transistor connected to the terminal to which the power supply voltage is applied, the second transistor having a gate to which the second control signal is applied. The output unit may also include a third transistor connected between the first transistor and a terminal from which the booster input voltage is output, the third transistor having a gate to which the comparison voltage is applied. The output unit may also include a fourth transistor connected between the second transistor and the transistor from which the booster input voltage is output, the fourth transistor having a gate to which the comparison voltage is applied.

The first transistor may have a smaller width than the second transistor.

According to exemplary embodiments of the present invention, a display device includes a controller configured to output an operation mode signal and a display control signal. A voltage boosting circuit may be configured to output a boost voltage in response to the operation mode signal. A display driver may be configured to output a plurality of driving voltages may be configured to display an image or information in response to the plurality of driving voltages. The voltage boosting circuit may include a booster input voltage generator configured to receive a power supply voltage, operate with a first current drive capability, and generate a booster input voltage in a switched mode in which the voltage boosting circuit switches from a standby mode to an operation mode. The booster input voltage generator may also be configured to receive the power supply voltage, operate with a second current drive capability higher than the first current drive capability, and generate the booster input voltage in the operation mode. A booster may be configured to receive the booster input voltage and generate a boost voltage.

The booster input voltage generator may include an input voltage controller configured to disable both a first control signal and a second control signal in the standby mode, enable the first control signal and disable the second control signal in the switched mode, enable both the first and second control signals in the operation mode, and output the first and second control signals. An input voltage driver may be configured to receive the power supply voltage, drive the power supply voltage with the first current drive capability in response to the first control signal in the switched mode, drive the power supply voltage with the second current drive capability in response to the first and second control signals in the operation mode, and generate the booster input voltage.

In an exemplary embodiment of the present invention, the input voltage driver may include a first transistor connected between a terminal to which the power supply voltage is applied and a terminal from which the booster input voltage is output, the first transistor having a gate to which the first control signal is applied. A second transistor may be connected between the terminal to which the power supply voltage is applied and the terminal from which the booster input voltage is output, the second transistor having a gate to which the second control signal is applied.

In an exemplary embodiment of the present invention, the input voltage driver may include a reference voltage generator configured to receive the power supply voltage and generate a reference voltage. A comparison voltage generator may be configured to receive the reference voltage and a feedback voltage, compare the feedback voltage with the reference voltage, and output a comparison voltage in response to a difference between the reference voltage and the feedback voltage. An output unit may be configured to receive the power supply voltage in response to the comparison voltage and generate the booster input voltage, have the first current drive capability in response to the first control signal in the switched mode, and have the second current drive capability in response to the first and second control signals in the operation mode; and a feedback voltage generator configured to receive the booster input voltage and generate the feedback voltage in proportion to the booster input voltage. The output unit may include a first transistor connected to a terminal to which the power supply voltage is applied, the first transistor having a gate to which the first control signal is applied. A second transistor may be connected to the terminal to which the power supply voltage is applied, the second transistor having a gate to which the second control signal is applied. A third transistor may be connected between the first transistor and a terminal from which the booster input voltage is output, the third transistor having a gate to which the comparison voltage is applied. A fourth transistor may be connected between the second transistor and the transistor from which the booster input voltage is output, the fourth transistor having a gate to which the comparison voltage is applied.

The first transistor may have a smaller width than the second transistor.

### BRIEF DESCRIPTION OF THE DRAWINGS

Exemplary embodiments of the present invention are described in further detail below with reference to the accompanying drawings. It should be understood that various aspects of the drawings may have been exaggerated for clarity:

FIG. 1 is a diagram showing a voltage boosting circuit according to exemplary embodiments of the present invention;

FIG. 2 is a timing diagram illustrating operation of an input voltage controller of the voltage boosting circuit of FIG. 1;

FIG. 3 is a diagram showing an input voltage driver of the voltage boosting circuit of FIG. 1, according to exemplary embodiments of the present invention;

FIG. 4 is a diagram showing an input voltage driver of the voltage boosting circuit of FIG. 1, according to exemplary embodiments of the present invention;

FIG. 5 is a diagram showing a booster of the voltage boosting circuit of FIG. 1; and

FIG. 6 is a diagram showing a display device including a voltage boosting circuit according to exemplary embodiments of the present invention.

### DETAILED DESCRIPTION OF EXEMPLARY EMBODIMENTS

Various exemplary embodiments will now be described more fully with reference to the accompanying drawings.

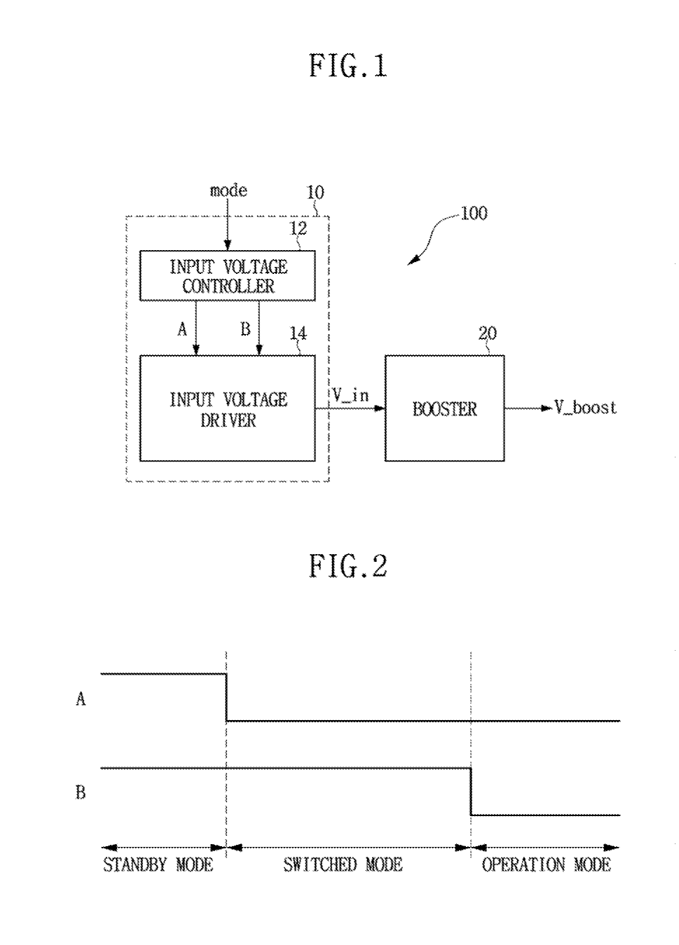

FIG. 1 is a diagram showing a voltage boosting circuit according to exemplary embodiments of the present invention.

Referring to FIG. 1, the voltage boosting circuit 100 may include a booster input voltage generator 10 and a booster 20. The booster input voltage generator 10 may include an input voltage controller 12 and an input voltage driver 14.

Functions of the respective blocks of FIG. 1 will now be described.

In a switched mode, the booster input voltage generator 10 may receive a power supply voltage, operate with a first current drive capability, and generate a booster input voltage V_in in response to an operation mode signal “mode.” In an operation mode, the booster input voltage generation unit 10 may receive the power supply voltage, operate with a second current drive capability higher than the first current drive capability, and generate the booster input voltage V_in in response to the operation mode signal “mode.” The operation mode signal “mode” may indicate a standby mode, a switched mode, and the operation mode. In the standby mode, the voltage boosting circuit 100 does not need to operate. For example, a display device does not need to operate a display panel. In the operation mode, the voltage boosting circuit 100 needs to operate and supply a boost voltage. For example, a display device may operate a display panel in an operation mode. In the switched mode, the voltage boosting circuit 100 switches from the standby mode to the operation mode. For example, the switched mode is a mode between the standby mode and the operation mode. Although FIG. 1 illustrates that the booster input voltage generator 10 operates in response to the operation mode signal “mode,” it may be determined if the booster input voltage generator 10 is in the standby mode, the switched mode, or the operation mode. The booster input voltage generator 10 may be configured to generate the booster input voltage V_in with a current drive capability that is dependent upon the determined mode.

The input voltage controller 12 may output a control signal including a first control signal A and a second control signal B in response to the operation mode signal “mode.” For example, the input voltage controller 10 may be configured to disable both the first and second control signals A and B in response to the operation mode signal “mode” indicating the standby mode, enable the first control signal A and disable the second control signal B in response to the operation mode signal “mode” indicating the switched mode, and enable both the first and second control signals A and B in response to the operation mode signal “mode” indicating the operation mode. Although FIG. 1 illustrates a case where the input voltage controller 10 outputs the first and second control signals A and B in response to the operation mode signal “mode,” the input voltage controller 10 may be configured to determine the operation mode signal “mode” by itself and output the first and second control signals A and B depending upon the determined operation mode.

The input voltage driver 14 may generate the booster input voltage V_in and vary current drive capability in response to the control signals A and B output by the input voltage controller 12. For example, in the standby mode, the input voltage driver 14 may have a current drive capability of 0 in response to the disabled first and second control signals A and B. Thus, in the standby mode, the input voltage driver 14 may drive no current. In the switched mode, the input voltage driver 14 may have the first current drive capability in response to the enabled first control signal A and the disabled second control signal B, drive the power supply voltage, and generate the booster input voltage V_in. In the operation mode, the input voltage driver 14 may have the second current drive capability in response to the enabled first and second control signals A and B, drive the power supply voltage, and generate the booster input voltage V_in. Here, the input voltage driver 14 may supply a first current at maximum when the input voltage driver 14 has the first current drive capability, and supply a second current larger than the first current at maximum when the input voltage driver 14 has the second current drive capability. Thus, in the operation mode, the input voltage driver 14 may drive greater current then in the switched mode.

The booster 20 may receive the booster input voltage V_in from the input voltage generator 10, boost the booster input voltage V_in, and output a boost voltage V_boost.

FIG. 2 is a timing diagram illustrating operation of the input voltage controller of the booster input voltage generation unit of the voltage boosting circuit of FIG. 1. In FIG. 2, reference character A denotes the first control signal output by the input voltage controller 12, and B denotes the second control signal output by the input voltage controller 12.

Operation of the input voltage controller 12 will now be described with reference to FIG. 2.

In FIG. 2, as shown, the first and second control signals A and B are “enabled” when they are at a relatively low level and “disabled” when they are at a relatively high level. The input voltage controller 12 may be configured to output each of the first and second control signals A and B, disabled to a high level, in the standby mode. The input voltage controller 12 may be configured to output the first control signal A, enabled to a low level, and output the second control signal B, disabled to a high level, in the switched mode. The input voltage controller 12 may be configured to output each of the first and second control signals A and B, enabled to a low level, in the operation mode.

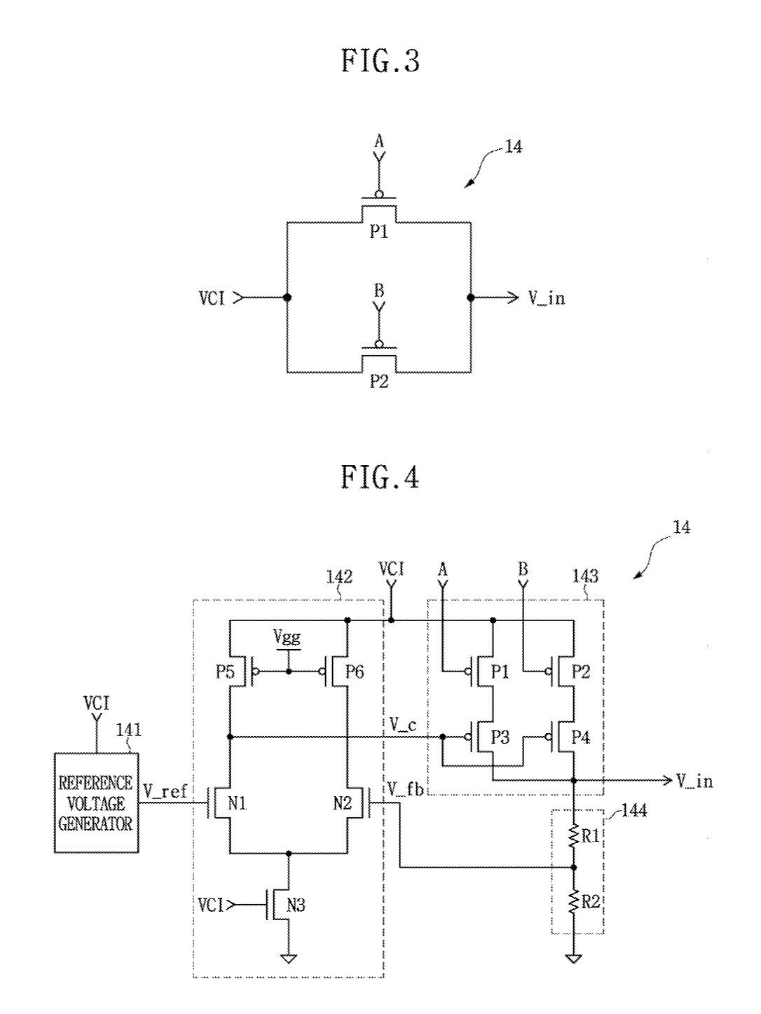

FIG. 3 is a diagram showing an input voltage driver of the booster input voltage generator of the voltage boosting circuit of FIG. 1, according to exemplary embodiments of the present invention.

Referring to FIG. 3, the input voltage driver 14 may include a first PMOS transistor P1 and a second PMOS transistor P2. The first PMOS transistor P1 may be connected between a terminal to which an external power supply voltage VC1 is applied and a terminal from which the booster input voltage V_in is output. The first PMOS transistor P1 may have a gate to which the first control signal A is applied. The second PMOS transistor P2 may be connected between the terminal to which the external power supply voltage VC1 is applied and the terminal from which the booting unit input voltage V_in is output. The second PMOS transistor P2 may have a gate to which the second control signal B is applied. Also, the second PMOS transistor P2 may be configured to have a greater width than that of the first PMOS transistor P1. The power supply voltage VC1 may be externally applied to the voltage boosting circuit 100 or a display device.

Function and operation of the input voltage driver 14 of the booster input voltage generator 10 of the voltage boosting circuit 100 of FIG. 3 will now be described.

In the standby mode, the PMOS transistors P1 and P2 of the input voltage driver 14 may both be turned off in response to the first and second control signals A and B that are disabled to the high level. Thus, in the standby mode, the input voltage driver 14 may have the current drive capability of 0 and output no booster input voltage V_in.

In the switched mode, the first PMOS transistor P1 of the input voltage driver 14 may be turned on in response to the first control signal A that is enabled to the low level, and the second PMOS transistor P2 may be turned off in response to the second control signal B that is disabled to the high level. Thus, in the switched mode, the input voltage driver 14 may output the booster input voltage V_in having a level of the power supply voltage VC1, and the current drive capability of the input voltage driver 14 may depend on the largest possible current flowing through the first PMOS transistor P1. That is, the maximum current that may flow through the input voltage driver 14 in the switched mode may be limited to the first current that may flow through the first PMOS transistor P1.

In the operation mode, the PMOS transistors P1 and P2 of the input voltage driver 14 may be turned on in response to the first and second control signals A and B that are enabled to the low level. Thus, in the operation mode, the input voltage driver 14 may output the booster input voltage V_in having a level of the external power supply voltage VC1, and the current drive capability of the input voltage driver 14 may depend on the largest possible current flowing through the first and second PMOS transistors P1 and P2. For example, the maximum current that may flow through the input voltage driver 14 in the operation mode may be limited to the second current larger than the first current.

FIG. 4 is a diagram showing the input voltage driver of the booster input voltage generator of the voltage boosting circuit of FIG. 1, according to exemplary embodiments.

Referring to FIG. 4, the input voltage driver 14 may include a reference voltage generator 141, a comparison voltage generator 142, an output unit 143, and a feedback voltage generator 144. Also, the comparison voltage generator 142 may include a mirror differential amplifier, which includes PMOS transistors P5 and P6 and NMOS transistors N1, N2, and N3. The output unit 143 may include first through fourth PMOS transistors P1 to P4. The first PMOS transistor P1 may be connected to a terminal to which the power supply voltage VC1 is applied and receive the first control signal A. The second PMOS transistor P2 may be connected to the terminal to which the power supply voltage VC1 is applied and receive the second control signal B. The third PMOS transistor P3 may be connected between the first PMOS transistor P1 and a terminal from which the booster input voltage V_in is output and include a gate to which a comparison voltage V_c is applied. The fourth PMOS transistor P4 may be connected between the second PMOS transistor P2 and the terminal from which the booster input voltage V_in is output and include a gate to which the comparison voltage V_c is applied. The feedback voltage generator 144 may include resistors R1 and R2 that are connected in series between the terminal from which the booster input voltage V_in is output and a ground voltage.

Functions of the respective blocks of FIG. 4 will now be described.

The reference voltage generator 141 may receive the power supply voltage VC1 and generate a reference voltage V_ref. The power supply voltage VC1 may be externally applied to the voltage boosting circuit 100 or the display device.

The comparison voltage generator 142 may receive the reference voltage V_ref and a feedback voltage V_fb, compare the feedback voltage V_fb with the reference voltage V_ref, and output the comparison voltage V_c in response to a difference between the reference voltage V_ref and the feedback voltage V_fb.

The output unit 143 may output the booster input voltage V_in in response to the comparison voltage V_c and vary the current drive capability in response to the first and second control signals A and B. The variation of the current drive capability in response to the first and second control signals A and B will be described with reference to FIG. 3. For example, in the switched mode, only the first control signal A may be enabled to the low level so that the maximum current supplied by the output unit 143 may be limited to the first current that may flow through the first PMOS transistor P1. However, in the operation mode, both the first and second control signals A and B are enabled to the low level, so that the maximum current supplied by the output unit 143 may be the second current that may flow through the first and second PMOS transistors P1 and P2. Here, the second current may be larger than the first current.

The feedback voltage generator 144 may be a voltage divider including serially connected resistors. The feedback voltage generator 144 may receive the booster input voltage V_in and output a feedback voltage V_fb in proportion to the booster input voltage V_in.

Therefore, in the input voltage driver 14 of the booster input voltage generator 10 of the voltage boosting circuit 100 of FIGS. 3 and 4 according to various exemplary embodiments of the present invention, the maximum current supplied by the input voltage driver 14 may be limited to the first current, which may flow through the first PMOS transistor P1, in the switched mode, thereby preventing an inrush current. Also, in the operation mode, the maximum current supplied by the input voltage driver 14 may be the second current, which may flow through the first and second PMOS transistors P1 and P2 and be larger than the first current, so that the input voltage driver 14 may supply a sufficient current to the booster 20.

Furthermore, in the input voltage driver 14 of the booster input voltage generator 10 of the voltage boosting circuit 100 of FIGS. 3 and 4 according to various exemplary embodiments of the present invention, the second PMOS transistor P2 may be configured to a greater width than the first PMOS transistor P1 and/or the second current may be larger than the first current.

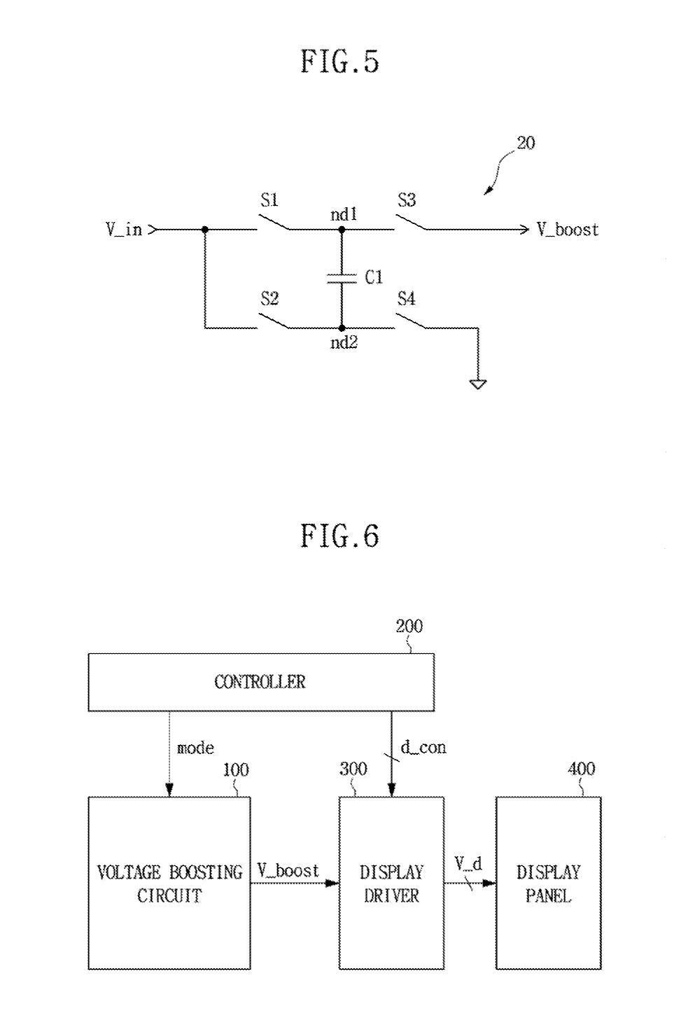

FIG. 5 is a diagram showing the booster 20 of the voltage boosting circuit of FIG. 1.

Referring to FIG. 5, the booster 20 may include a capacitor C1 and first through fourth switches S1 to S4. The capacitor C1 may be connected between a first node nd1 and a second node nd2. The first switch S1 may be connected between a terminal to which the booster input voltage V_in is applied and the first node nd1. The second switch S2 may be connected between the terminal to which the booster input voltage V_in is applied and the second node nd2. The third switch S3 may be connected between the first node nd1 and a terminal from which the boost voltage V_boost is output. The fourth switch S4 may be connected between the second node nd2 and a ground voltage.

Function and operation of the booster 20 of FIG. 5 will now be described.

The first and fourth switches S1 and S4 may be turned on and the capacitor C1 may be charged using the booster input voltage V_in. Next, the second and third switches S2 and S3 may be turned on, and thus the booster 20 may output the boost voltage V_boost using the booster input voltage V_in and a voltage with which the capacitor C1 is charged.

Specifically, the booster 20 of FIG. 5 according to exemplary embodiments of the present invention may output the boost voltage V_boost that doubles the booster input voltage V_in. Although not shown, the voltage boosting circuit 100 may include a plurality of boosters 20 configured to output boost voltages having various levels. In this case, each of the boosters 20 may have the same configuration as in FIG. 5. Also, although not shown, the booster 20 of the voltage boosting circuit 100 may be configured to not only a positive boost voltage but also a negative boost voltage.

FIG. 6 is a diagram showing a display device including a voltage boosting circuit according to exemplary embodiments of the present invention.

Referring to FIG. 6, the display device may include a voltage boosting circuit 100, a controller 200, a display driver 300, and a display panel 400.

Functions of the respective blocks of FIG. 6 will now be described.

The voltage boosting circuit 100 may have the same configuration as in FIGS. 1 through 5. The voltage boosting circuit 100 may output a boost voltage V_boost in response to an operation mode signal “mode” output by the controller 200 and vary current drive capability according to the operation mode signal “mode.” The voltage boosting circuit 100 may be configured to output a plurality of boost voltages.

The controller 200 may output the operation mode signal “mode” according to an operation state of the display device and output a display control signal d_con to display an image or information on the display panel 400. For example, the operation state may be a standby mode, a switched mode, or an operation mode.

The display driver 300 may receive the boost voltage V_boost from the voltage boosting circuit 100 and output a plurality of driving voltages V_d in response to the display control signal d_con output by the controller 200.

The display panel 400 may display an image or information in response to the plurality of driving voltages V_d output by the display driver 300.

Although FIG. 6 illustrates that the controller 200 outputs the operation mode signal “mode,” the controller 200 may be configured to directly output the first and second control signals A and B according to the operation state, for example, the standby mode, the switched mode, or the operation mode. In this case, the booster input voltage generator 10 of the voltage boosting circuit 100 may include only the input voltage driver 14.

As described above, a voltage boosting circuit according to exemplary embodiments of the present invention may be applied to a display device. Alternatively, however, the voltage boosting circuit according to exemplary embodiments of the present invention may be applied to other devices.

Therefore, according to exemplary embodiments of the present invention, a voltage boosting circuit and a display device including the same may reduce or eliminate the frequency and/or severity of an inrush current, thus preventing an integrated circuit (IC) of a display device from being damaged due to the inrush current.

While exemplary embodiments of the present invention have been described herein, it should be understood that other variations may be possible.

What is claimed is:

1. A voltage boosting circuit comprising:
a booster input voltage generator configured to receive a power supply voltage and generate a booster input voltage; and
a booster configured to receive the booster input voltage and generate a boost voltage based on the received booster input voltage,
wherein the booster input voltage generator is configured to operate in a standby mode, an operation mode, and a switched mode in which the booster input voltage generator transitions between the standby mode and the operation mode, such that:
when the booster input voltage generator is operating in the switched mode, the voltage generator operates with a first current drive capability; and
when the booster input voltage generator is operating in the operation mode, the voltage generator operates with a second current drive capability that is greater than the first current drive capability.

2. The voltage boosting circuit of claim 1, wherein the booster input voltage generator comprises an input voltage controller configured to:
disable both a first control signal and a second control signal in the standby mode;
enable the first control signal and disable the second control signal in the switched mode;
enable both the first and second control signals in the operation mode; and
output the first and second control signals.

3. The voltage boosting circuit of claim 2, wherein the booster input voltage generator further comprises an input voltage driver configured to:
receive the power supply voltage;
drive the power supply voltage with the first current drive capability in response to the first control signal in the switched mode;
drive the power supply voltage with the second current drive capability in response to the first and second control signals in the operation mode; and
generate the booster input voltage.

4. The voltage boosting circuit of claim 3, wherein the input voltage driver comprises:
a first input transistor connected between a terminal to which the power supply voltage is applied and a terminal from which the booster input voltage is output, the first input transistor having a gate to which the first control signal is applied; and
a second input transistor connected between the terminal to which the power supply voltage is applied and the terminal from which the booster input voltage is output, the second input transistor having a gate to which the second control signal is applied.

5. The circuit of claim 4, wherein the first input transistor has a smaller width than the second input transistor.

6. The circuit of claim 3, wherein the input voltage driver comprises:
a reference voltage generator configured to receive the power supply voltage and generate a reference voltage;
a comparison voltage generator configured to receive the reference voltage and a feedback voltage, compare the feedback voltage with the reference voltage, and output a comparison voltage in response to a difference between the reference voltage and the feedback voltage;
an output unit configured to receive the power supply voltage in response to the comparison voltage and generate the booster input voltage operating with the first current drive capability in response to the first control signal in the switched mode and operating with the second current drive capability in response to the first and second control signals in the operation mode; and
a feedback voltage generator configured to receive the booster input voltage and generate the feedback voltage in proportion to the booster input voltage.

7. The voltage boosting circuit of claim 6, wherein the output unit comprises:
a first output transistor connected to a terminal to which the power supply voltage is applied, the first output transistor having a gate to which the first control signal is applied;
a second output transistor connected to the terminal to which the power supply voltage is applied, the second output transistor having a gate to which the second control signal is applied;
a third output transistor connected between the first output transistor and a terminal from which the booster input voltage is output, the third output transistor having a gate to which the comparison voltage is applied; and
a fourth output transistor connected between the second output transistor and the terminal from which the booster input voltage is output, and having a gate to which the comparison voltage is applied.

8. The voltage boosting circuit of claim 6, wherein the first output transistor has a smaller width than the second output transistor.

9. A display device comprising:
a controller configured to output an operation mode signal and a display control signal;
a voltage boosting circuit configured to receive the operation mode signal and output a boost voltage in response to the operation mode signal;
a display driver configured to receive the boost voltage and the display control signal and to output a plurality of driving voltages, using the boost voltage, in response to the display control signal; and
a display panel configured to display an image in response to the plurality of driving voltages,
wherein the voltage boosting circuit comprises:
a booster input voltage generator configured to receive a power supply voltage and generate a booster input voltage; and
a booster configured to receive the booster input voltage and generate a boost voltage based on the received booster input voltage,
wherein the booster input voltage generator is configured to operate in a standby mode, an operation mode, and a switched mode in which the booster input voltage generator transitions between the standby mode and the operation mode, such that:
when the booster input voltage generator is operating in the switched mode, the voltage generator operates with a first current drive capability; and
when the booster input voltage generator is operating in the operation mode, the voltage generator operates with a second current drive capability that is greater than the first current drive capability.

10. The display device of claim 9, wherein the booster input voltage generator comprises an input voltage controller configured to
disable both a first control signal and a second control signal in the standby mode;
enable the first control signal and disable the second control signal in the switched mode;
enable both the first and second control signals in the operation mode; and
output the first and second control signals.

11. The display device of claim 10, wherein the booster input voltage generator further comprises an input voltage driver configured to:
receive the power supply voltage;
drive the power supply voltage with the first current drive capability in response to the first control signal in the switched mode;
drive the power supply voltage with the second current drive capability in response to the first and second control signals in the operation mode; and
generate the booster input voltage.

12. The display device of claim 11, wherein the input voltage driver comprises:
a first input transistor connected between a terminal to which the power supply voltage is applied and a terminal from which the booster input voltage is output, the first input transistor having a gate to which the first control signal is applied; and
a second input transistor connected between the terminal to which the power supply voltage is applied and the terminal from which the booster input voltage is output, the second input transistor having a gate to which the second control signal is applied.

13. The display device of claim 12, wherein the first input transistor has a smaller width than the second input transistor.

14. The display device of claim II, wherein the input voltage driver comprises:
a reference voltage generator configured to receive the power supply voltage and generate a reference voltage;
a comparison voltage generator configured to receive the reference voltage and a feedback voltage, compare the feedback voltage with the reference voltage, and output a comparison voltage in response to a difference between the reference voltage and the feedback voltage;
an output unit configured to receive the power supply voltage in response to the comparison voltage and generate the booster input voltage, operating with the first current drive capability in response to the first control signal in the switched mode, and operating with the second current drive capability in response to the first and second control signals in the operation mode; and
a feedback voltage generator configured to receive the booster input voltage and generate the feedback voltage in proportion to the booster input voltage.

15. The display device of claim 14, wherein the output unit comprises:
a first output transistor connected to a terminal to which the power supply voltage is applied, the first output transistor having a gate to which the first control signal is applied;
a second output transistor connected to the terminal to which the power supply voltage is applied, the second output transistor having a gate to which the second control signal is applied;
a third output transistor connected between the first output transistor and a terminal from which the booster input voltage is output, the third output transistor having a gate to which the comparison voltage is applied; and
a fourth output transistor connected between the second transistor and the terminal from which the booster input voltage is output, and having a gate to which the comparison voltage is applied.

16. The display device of claim 15, wherein the first transistor has a smaller width than the second transistor.

17. A voltage boosting circuit comprising:
a voltage generator receiving a power supply voltage and generating a booster input voltage in response to a mode signal indicating a standby mode, an operation mode or a switched mode representing a mode between the standby mode and the operation mode, wherein the voltage boosting circuit operates at a first drive capability when the mode signal indicates the switched mode and operates at a second drive capability, larger than the first drive capability, when the mode signal indicates the operation mode; and
a booster configured to receive the booster input voltage from the voltage generator, boost the received booster input voltage and output a boost voltage,
wherein the voltage boosting circuit comprises an input voltage controller configured to output a control signal in response to the operation mode signal, and an input voltage driver configured to generate the booster input voltage while varying a current drive capability in response to the control signal output by the input voltage controller.

18. The voltage boosting circuit of claim 17, wherein the control signal includes a first control signal and a second control signal wherein the first control signal is disabled and the second control signal disabled when the operation mode signal indicates a standby mode, the first control signal is enabled and the second control signal is disabled when the operation mode signal indicates a switched mode, and the first control signal is enabled and the second control signal is enabled when the operation mode signal indicates an operation mode.

19. The voltage boosting circuit of claim 17, wherein the voltage boosting circuit is inoperable when the mode signal indicates the standby mode.
